(19) United States
(12) Patent Application Publication
(10) Pub. No.: US 2008/0091888 A1
(43) Pub. Date: Apr. 17, 2008

(54) MEMORY SYSTEM HAVING BASEBOARD LOCATED MEMORY BUFFER UNIT

(75) Inventor: Douglas L. Sandy, Chandler, AZ (US)

Correspondence Address: MOTOROLA, INC., LAW DEPARTMENT, 1303 E. ALGONQUIN ROAD, SCHAUMBURG, IL, 60196, US

(73) Assignee: MOTOROLA, INC., Schaumburg, IL (US)

(21) Appl. No.: 11/550,313

(22) Filed: Oct. 17, 2006

(51) Int. Cl. G06F 13/00; G06F 12/00

(52) U.S. Cl. 711/154; 711/118

(57) ABSTRACT

A memory system includes a memory controller disposed on a baseboard, and a plurality of memory devices disposed on at least one memory module, where the at least one memory module is coupled to but separate from the baseboard. A memory buffer unit disposed on the baseboard, where the memory buffer unit is coupled to the memory controller, where the memory buffer unit is coupled to the at least one memory module, where the memory buffer unit is adapted to serialize and deserialize data communicated between the memory controller and the plurality of memory devices, and where the memory buffer is adapted to route the data among the plurality of memory devices.

### BACKGROUND OF INVENTION

Memory subsystems for embedded computing platforms have stringent design constraints for board real-estate, configurability, performance, form factor and memory module height. Memory technologies such as Fully Buffered Dual In-Line Memory Modules (FB-DIMM) adequately address the need for high-performance DIMM arrays that are easy to route. However, these DIMM modules are too large to fit vertically within many embedded computing form factors.

Very Low Profile DIMMs (VLP-DIMM) adequately address the problems associated with high-density board layouts (i.e. allowing for many DIMM modules in a given surface area), and are short enough to be accommodated within compact embedded computing form factors such as ATCA, MicroTCA, and the like. However, VLP-DIMM modules suffer from the same loading constraints as standard DIMM modules, making large arrays of memory modules unrealistic due to electrical loading and/or trace routing complexity.

There is a need, not met in the prior art, for a low-profile memory module configuration that avoids electrical loading constraints and/or trace routing constraints of the prior art, while incorporating the advantages of newer, high-performance memory technologies.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates a block diagram of a prior art memory system;

FIG. 2 representatively illustrates a block diagram of another prior art memory system;

FIG. 3 representatively illustrates a block diagram of a memory buffer unit in accordance with an exemplary embodiment of the present invention;

FIG. 4 representatively illustrates a block diagram of a computer system in accordance with an exemplary embodiment of the present invention; and

FIG. 5 representatively illustrates a block diagram of a memory system in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

The terms “a” or “an”, as used herein, are defined as one, or more than one. The term “plurality,” as used herein, is defined as two, or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. A component may include a computer program, software application, or one or more lines of computer readable processing instructions.

Software blocks that perform embodiments of the present invention can be part of computer program modules comprising computer instructions, such control algorithms that are stored in a computer-readable medium such as memory. Computer instructions can instruct processors to perform any methods described below. In other embodiments, additional modules could be provided as needed.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

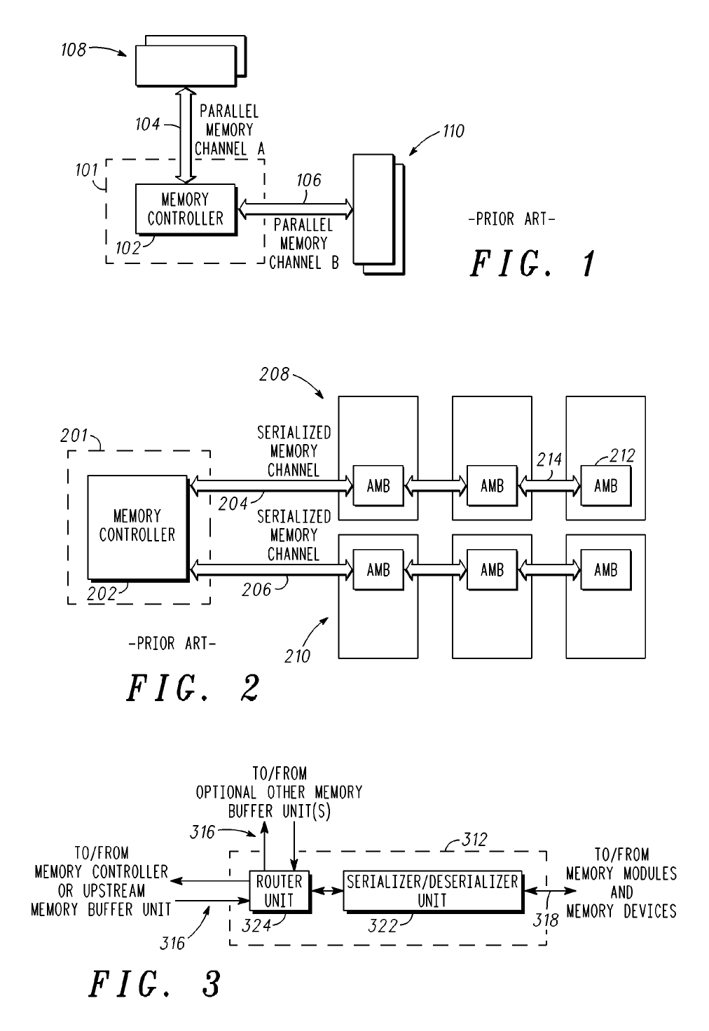

FIG. 1 representatively illustrates a block diagram of a prior art memory system 100. In the prior art memory system 100, a memory controller 102 is coupled, via a parallel memory channel 104, 106 to a memory module 108, 110. The memory controller 102 is mounted on a baseboard 101, such as a motherboard, payload board, and the like. Each parallel memory channel 104, 106 can couple memory controller 102 to an array of memory sockets (also on the baseboard 101), each containing a memory module 108, 110, which is generally a dual in-line memory module (DIMM) having any number of memory devices, such as dynamic random access memory (DRAM), static random access memory (SRAM), etc. The most common types of DIMMs are: 72-pin-DIMMs, used for SO-DIMM; 144-pin-DIMMs, used for SO-DIMM; 200-pin-DIMMs, used for SO-DIMM; 168-pin-DIMMs, used for FPM, EDO and SDRAM; 184-pin-DIMMs, used for DDR SDRAM; and 240-pin-DIMMs, used for DDR2 SDRAM. The number of ranks on any DIMM is the number of independent sets of DRAMs that can be accessed simultaneously for the full data bit-width of the DIMM to be driven on the parallel memory channel 104, 106. The physical layout of the DRAM chips on the DIMM itself does not necessarily relate to the number of ranks. Sometimes the layout of all DRAM on one side of the DIMM PCB versus both sides is referred to as “single-sided” versus “double-sided”.

There are several common form factors for commonly used DIMMs. Single Data Rate (SDR) SDRAM DIMMs come in two main sizes: 1.7″ and 1.5″. 1U rackmount servers require angled DIMM sockets to fit in the 1.75″ high box. To accommodate this form factor, Double Data Rate (DDR) DIMMs are available with a “Low Profile” (LP) height of ˜1.2″. These fit into vertical DIMM sockets for a 1U platform. With the advent of blade servers, the Low Profile (LP) form factor DIMMs are angled to fit in these space-constrained boxes. The Very Low Profile (VLP) form factor DIMM with a height of ˜0.72″ (18.3 mm) may be used for this application. Other DIMM form factors include the small outline DIMM (SO-DIMM), the Mini-DIMM and the VLP Mini-DIMM. SO-DIMMs are a smaller alternative to a DIMM, being roughly half the size of regular DIMMs.

The parallel memory channels 104, 106 used in the prior art have a number of disadvantages. Each memory device (DDR chip for instance) connected to the parallel memory channel 104, 106 applies a capacitive load to the channel. These load capacitances are normally attributed to components of input/output (I/O) structures disposed on an integrated circuit (IC) device, such as a memory device. For example, bond pads, electrostatic discharge devices, input buffer transistor capacitance, and output driver transistor parasitic and interconnect capacitances relative to the IC device substrate all contribute to the memory device load capacitance.

The load capacitances connected to multiple points along the length of the parallel memory channel 104, 106 may degrade signaling performance. As more load capacitances are introduced along the parallel memory channel 104, 106, signal settling time correspondingly increases, reducing the bandwidth of the memory system. In addition, impedance along the parallel memory channel 104, 106 may become harder to control or match as more load capacitances are present (i.e. more memory devices are added). Mismatched impedance may introduce voltage reflections that cause signal detection errors. Thus, for at least these reasons, increasing the number of loads along the parallel memory channel 104, 106 imposes a compromise to the bandwidth of the memory system. As clock speeds increase, the number of DIMM sockets on a parallel memory channel 104, 106 becomes limited by this capacitance, thereby limiting the size of memory per parallel memory channel 104, 106.

A solution to this is to provide more than one parallel memory channel 104, 106 as shown in FIG. 1. However, due to the number of trace routings per parallel memory channel 104, 106 (˜150 traces per channel), congestion around in the vicinity of the memory controller 102 effectively limits this option.

FIG. 2 representatively illustrates a block diagram of another prior art memory system 200. In the prior art memory system 200, a memory controller 202 is coupled, via a serialized memory channel 204, 206 to one or more memory module 208, 210. The memory controller 202 is mounted on a baseboard 201, such as a motherboard, payload board, and the like. Each serialized memory channel 204, 206 can couple memory controller 202 to an array of memory sockets (also on the baseboard 201), each containing a memory module 208, 210.

Prior art memory system 200 uses a Fully-Buffered DIMM (FB-DIMM) as a memory module 208, 210. The FB-DIMM memory channel between the memory controller 202 and the memory devices mounted on the memory modules 208, 210 is split into two independent signaling interfaces with a buffer 212 between them. The interface between the buffer 212 and memory devices is the same parallel memory channel supporting standard DIMMs. However, the interface between the memory controller 202 and the buffer 212 is changed from a parallel memory channel to a serialized memory channel 204, 206.

FB-DIMMs utilize the JEDEC standard (www.jdec.org) for Double Data Rate2 (DDR2), Double Data Rate 3 (DDR3) SDRAM, and future DDRx implementations. FB-DIMM memory modules are Fully-Buffered using the high-speed Advanced Memory Buffer (AMB) 212. Unlike normal DIMM modules which are connected by a parallel memory channel to the memory controller 202, FB-DIMM memory modules are connected to the memory controller 202 using a serialized memory channel 204, 206.

The AMB 212, which is “on board” the memory module 208, 210, provides a bi-directional interconnect to the memory controller 202 (northbound) on the baseboard 201, and a different bi-directional interconnect (serialized daisy-chain link 214) to the next FB-DIMM in the bank (southbound). The second FB-DIMM connects to the first FB-DIMM (northbound) and the next one in the chain (southbound). Memory devices on the FB-DIMM memory modules 208, 210 use a parallel memory channel to communicate with the AMB 212.

Using serial communication, the number of wires needed to connect the memory controller 202 to the memory module 208, 210 is lower and also allows the creating of more memory channels, which increases memory performance. With FB-DIMM technology it is possible to have up to eight modules per channel and up to six memory channels. In addition, the point-to-point serial interconnection of AMB devices limits the loading on the memory channel, allowing the channel to operate at very high speeds. The use of FB-DIMM memory architecture allows for increases of both memory capacity and speed. Each extra memory channel that is added to the system increases the memory transfer rate. For example, a single DDR2-533 channel has a transfer rate of 4,264 MB/s. Two DDR2-533 channels have a transfer rate of 8,528 MB/s. Four channels have a memory transfer rate of 17,056 MB/s.

FB-DIMM modules communicate using a serialized memory interface protocol that uses 10 pairs of wires between the memory controller 202 and the memory sockets and 12 or 14 pairs of wires between the memory sockets and the memory controller 202. Each pair of wires use differential transmission, i.e. the signal is transmitted on a wire and the same signal but inverted is transmitted on the other wire, using the same idea used on twisted pair networking cables.

In the context of data storage and transmission a serialized memory interface protocol transmits across a network connection link, either as a series of bytes or in some human-readable format such as XML. The series of bytes or the format can be used to re-create an object that is identical in its internal state to the original object.

FB-DIMM memory modules have the same physical size as DDR2-DIMM modules. The advantages of using FB-DIMM memory modules are that the resulting memory subsystem can have greater capacity (due to more memory sockets) and higher performance (due to higher speeds and lower loading). Another advantage is the simplification in baseboard design, since the path between the chipset and the memory sockets uses fewer wires (˜69 instead of ˜240 per memory channel). Even though FB-DIMM memory modules use standard DDR2-DIMM sockets, which have 240 pins, they actually use only 69 of these pins, simplifying baseboard routing around the memory controller 202.

FB-DIMMs offer much greater memory capacity than standard DIMMs. However, the disadvantage of FB-DIMM memory modules 208, 210 is that the AMB 212 used on each FB-DIMM has a higher power consumption than standard DIMMs (making them difficult to cool) and are physically large such that they do not fit within the form factors of low-profile embedded computing chassis.

FIG. 3 representatively illustrates a block diagram of a memory buffer unit 312 in accordance with an exemplary embodiment of the present invention. The memory buffer unit 312 of FIG. 3 may be an Advanced Memory Buffer (AMB) unit analogous to the AMB described with reference to FIG. 2. As discussed above, memory buffer unit 312 moves data over a point-to-point architecture using a serialized memory interface protocol between the memory controller and the memory buffer unit 312, while moving data over a parallel memory channel between the memory buffer unit 312 and memory modules.

Memory buffer unit 312 may include, among other things, a serializer/deserializer unit 322 and a router unit 324. Memory buffer unit 312 is coupled to a memory controller or an upstream memory buffer unit via a serialized memory channel 316. Memory buffer unit 312 may also be coupled to other memory buffer units via serialized memory channel 316, where memory buffer unit 312 is daisy chained to the other memory buffer units. Serialized memory channel 316 is adapted to transmit data using a serialized memory interface protocol. Memory buffer unit 312 is coupled to memory modules via parallel memory channel 318, which is adapted to operate using a parallel memory interface protocol. Router unit 324 may operate to route data to memory modules and memory devices connected to memory buffer unit 312 (local memory modules), or to other memory buffer units connected to other memory modules (non-local memory modules) and memory devices. Although one serializer/deserializer unit 322 and associated router 324 is shown, this is not limiting of the invention. Any number of serializer/deserializer 322 units and associated routers 324 may exist within the memory buffer unit 312 in order to support multiple parallel memory channels, and be within the scope of the invention.

Serializer/deserializer unit 322 may operate to deserialize data communicated from memory controller to memory devices, and to serialize data communicated from memory devices to memory controller. Memory buffer unit 312 may take action in response to memory controller commands. Memory buffer unit 312 may deliver data between the memory controller and memory modules without alternation other than serialization/deserialization.

FIG. 4 representatively illustrates a block diagram of a computer system 400 in accordance with an exemplary embodiment of the present invention. Computer system 400 may include a computer chassis 403 and a baseboard 401. Computer chassis 403 may include any type of computer chassis, for example a desktop, chassis, laptop chassis, server chassis, embedded computer chassis (ATCA®, MicroTCA®, VME®, CompactPCI®, etc.), and the like. Baseboard 401 may be a motherboard, payload card, switch card, rear transition module, and the like. A processor unit 405 and a memory system 407 may be coupled to baseboard 401. Processor unit 405 may include any type of electronic processing devices, for example and without limitation, a central processor, and the like.

Memory system 407 may include a memory controller 402 and a plurality of memory devices interconnected with a memory buffer unit 412 providing access between the memory devices and an overall system, for example, a computer system 400. Memory system 407 includes at least one memory module socket 413 adapted to accept at least one memory module. Memory module socket 413 may be a type of socket adapted to receive a memory module, for example a socket adapted to receive a DIMM, and the like. A memory module denotes a substrate having a plurality of memory devices employed with a connector interface.

Although two memory buffer units 412 are shown along with four memory module sockets 413, this is not limiting of the invention. Any number of memory buffer units 412 and memory module sockets 413 are within the scope of the invention.

The computer system 400 of FIG. 4 includes memory buffer unit 412 on the baseboard 401 as opposed to the prior art, where the memory buffer unit 412 is located on each of the memory modules. In an embodiment, memory buffer unit 412 may be located on the same printed wire board (PWB) as the memory controller 402. In another embodiment, memory buffer unit 412 may be located on a different PWB as memory controller 402, but still not on a memory module.

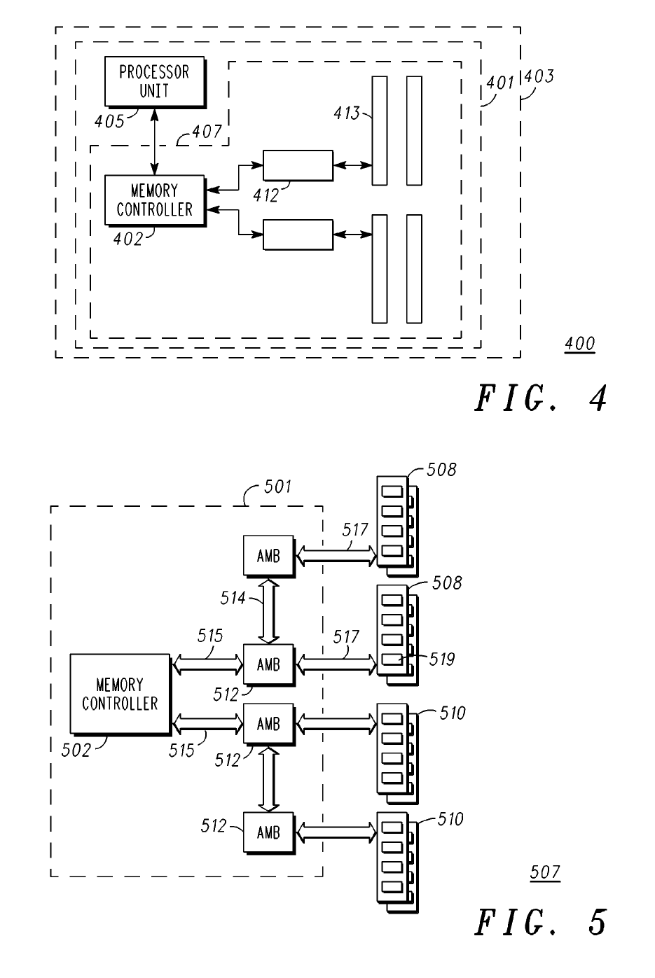

FIG. 5 representatively illustrates a block diagram of a memory system 507 in accordance with an exemplary embodiment of the present invention. Memory system 507 includes memory controller 502 connected to baseboard 501, and one or more memory buffer units 512 also connected to baseboard 501. In an embodiment, memory buffer unit 512 may be an AMB unit, and the like.

A plurality of memory module sockets may each contain a memory module 508, 510. Memory modules 508, 510 may be any combination of standard DIMMs, Very Low Profile DIMM (VLP-DIMM), a Small Outline DIMM (SO-DIMM), a Mini DIMM, and a VLP Mini-DIMM, and the like. Each memory module 508, 510 may contain a plurality of memory devices 519 adapted to store data. Plurality of memory devices 519 may include dynamic random access memory (DRAM), static random access memory (SRAM), and the like.

Memory controller 502 may be coupled to a memory buffer unit 512 via a serialized memory channel operating a serialized memory interface protocol 515. Serialized memory interface protocol 515 may transmit across a network connection link, either as a series of bytes or in some human-readable format such as XML. The series of bytes or the format may be used to re-create an object that is identical in its internal state to the original object. In an embodiment, serialized memory interface protocol 515 may be an FB-DIMM serialized memory interface protocol, a RAMBUS serialized memory interface protocol, and the like.

Memory buffer unit 512 may be daisy-chained to other memory buffer units not directed connected to memory controller 502, via a daisy chain link 514. In an embodiment, memory buffer unit 512 may be daisy chained to other memory buffer units via daisy chain link 514 also operating a serialized memory interface protocol 515. Each of memory buffer units 512 connected to memory controller 502, and other daisy-chained memory buffer units are located on baseboard 501, and not any of plurality of memory modules 508, 510.

In the embodiment shown, there are two serialized memory channels operating from memory controller 502. This is exemplary and not limiting of the invention. Any number of serialized memory channels may operating from memory controller 502 and be within the scope of the invention. Also, any number of serialized memory channels may be operated through a memory buffer unit 512.

Memory buffer unit 512 may be coupled to memory module sockets and memory modules 508, 510 via a parallel memory channel, which is adapted to operate using a parallel memory interface protocol 517. In an embodiment, parallel memory interface protocol 517 may include DDRx (DDR2, DDR3, etc.), SDRAM, EDO, and the like. These are not limiting and any parallel memory interface protocol 517 may be within the scope of the invention. Further, any number of parallel memory channels and parallel memory interface protocols 517 may be operated from memory buffer unit 512 and be within the scope of the invention.

By repartitioning the architecture to place the memory buffer unit 512 on the baseboard 501 instead of on each memory module 508, 510, numerous advantages are realized. First, the number of memory devices 519 that may be supported on the baseboard 501 is larger as the constraint of the physically smaller memory module 508, 510 is not present. In addition, each memory buffer unit 512 located on the baseboard 501 may support more parallel connections to memory modules 508, 510 and memory devices 519 than if the memory buffer unit 512 was located on the memory module 508, 510, where parallel communication can only be achieved with devices on the same module.

Secondly, the routing congestion near the memory controller 502 is reduced as the serial memory channels have many fewer routing traces than the prior art parallel memory channels. Thirdly, since each memory buffer unit 512 may support more memory devices 519, fewer memory buffer units 512 are needed for a given amount of memory. This translates to significantly lower power usage since fewer high powered memory buffer units 512 (usually 6-9 Watts) are needed.

Finally, the cooling requirements for the computer system are reduced and simplified. Since there are fewer memory buffer units 512, there is less heat generated. Also, cooling resources may be concentrated on the relatively easier to cool baseboard 501 as opposed to the relatively congested ranks of memory modules 508, 510 that require more elegant and expensive cooling solutions.

Since the memory buffer units 512 are located on the baseboard 501 instead of each memory module 508, 510, prior art memory modules 508, 510 including VLP-DIMMs may be used in applications where there are form factor limitations, for example in embedded computing chassis, and the like. Also, with the memory buffer units 512 on the baseboard 501, these form factor limited applications may incorporate more memory as trace routing limitations are alleviated, more of the smaller VLP-DIMMs may be used, less heat is generated, and cooling air may be concentrated on the baseboard 501 as opposed to a congested series of memory modules 508, 510. In summary, the above embodiments allow the advantages of FB-DIMM memory modules to be used with standard DIMMs and VLP-DIMMs in form factor limited applications where FB-DIMMs are too physically large to be used.

In the foregoing specification, the invention has been described with reference to specific exemplary embodiments. However, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A memory system, comprising:
a memory controller disposed on a baseboard;
a plurality of memory devices disposed on at least one memory module, wherein the at least one memory module is coupled to but separate from the baseboard; and
a memory buffer unit disposed on the baseboard, wherein the memory buffer unit is coupled to the memory controller, wherein the memory buffer unit is coupled to the at least one memory module, wherein the memory buffer unit is adapted to serialize and deserialize data communicated between the memory controller and the plurality of memory devices, and wherein the memory buffer unit is adapted to route the data among the plurality of memory devices.

2. The memory system of claim 1, wherein a serialized memory interface protocol is adapted to be used between the memory controller and the memory buffer unit.

3. The memory system of claim 1, wherein at least one parallel memory interface protocol is adapted to be used between the memory buffer unit and the plurality of memory devices.

4. The memory system of claim 1, wherein the memory buffer unit is an advanced memory buffer (AMB) unit.

5. The memory system of claim 1, wherein the at least one memory module consists of at least one of a Dual In-Line Memory Module (DIMM), a Very Low Profile DIMM (VLP-DIMM), a Small Outline DIMM (SO-DIMM), a Mini DIMM, and a VLP Mini-DIMM.

6. The memory system of claim 1, wherein the baseboard comprises at least one memory module socket adapted for receiving the at least one memory module.

7. The memory system of claim 1, wherein the memory buffer unit is daisy-chained with at least one other memory buffer unit.

8. A method of operating a memory system, comprising:
transmitting data between a memory controller and a memory buffer unit using a serialized memory interface protocol, wherein the memory controller and the memory buffer unit are disposed on a baseboard;
the memory buffer unit at least one of serializing and deserializing the data;
the memory buffer unit routing the data among a plurality of memory devices; and
transmitting the data between the memory buffer unit and at least one of the plurality of memory devices using at least one parallel memory interface protocol, wherein the plurality of memory devices are disposed on at least one memory module, and wherein the at least one memory module is coupled to but separate from the baseboard.

9. The method of claim 8, wherein the memory buffer unit is an advanced memory buffer (AMB) unit.

10. The method of claim 8, wherein at least one memory module consisting of at least one of a Dual In-Line Memory Module (DIMM), a Very Low Profile DIMM (VLP-DIMM), a Small Outline DIMM (SO-DIMM), a Mini DIMM, and a VLP Mini-DIMM.

11. The method of claim 8, wherein the baseboard comprising at least one memory module socket adapted for receiving the at least one memory module.

12. The method of claim 8, further comprising daisy-chaining the memory buffer unit with at least one other memory buffer unit.

13. The method of claim 8, further comprising operating the memory system within an embedded computer system.

14. A computer system, comprising:
a memory controller disposed on a baseboard;
a plurality of memory devices disposed on at least one memory module, wherein the at least one memory module is coupled to but separate from the baseboard; and
a memory buffer unit disposed on the baseboard, wherein the memory buffer unit is coupled to the memory controller, wherein the memory buffer unit is coupled to the at least one memory module, wherein the memory buffer unit is adapted to serialize and deserialize data communicated between the memory controller and the plurality of memory devices, and wherein the memory buffer unit is adapted to route the data among the plurality of memory devices.

15. The computer system of claim 14, wherein a serialized memory interface protocol is adapted to be used between the memory controller and the memory buffer unit.

16. The computer system of claim 14, wherein at least one parallel memory interface protocol is adapted to be used between the memory buffer unit and the plurality of memory devices.

17. The computer system of claim 14, wherein the memory buffer unit is an advanced memory buffer (AMB) unit.

18. The computer system of claim 14, wherein at least one memory module consists of at least one of a Dual In-Line Memory Module (DIMM), a Very Low Profile DIMM (VLP-DIMM), a Small Outline DIMM (SO-DIMM), a Mini DIMM, and a VLP Mini-DIMM.

19. The computer system of claim 14, wherein the baseboard comprises at least one memory module socket adapted for receiving the at least one memory module.

20. The computer system of claim 14, wherein the memory buffer unit is daisy-chained with at least one other memory buffer unit.
